(19) United States
(12) Patent Application Publication
(10) Pub. No.: US 2026/0220677 A1
(43) Pub. Date: Jul. 30, 2026

(54) SINGLE CATALOG PRODUCT UPDATE SYSTEM AND METHOD FOR THE SAME

(71) Applicant: D-MARKET ELEKTRONIK HIZMETLER VE TICARET ANONIM SIRKETI, Istanbul (TR)

(72) Inventors: Ersan ÖZTÜRK, Istanbul (TR); Erman CEYLAN, Istanbul (TR); Çaglar EKER, Istanbul (TR)

(21) Appl. No.: 19/146,671

(22) PCT Filed: Jan. 24, 2024
(86) PCT No.: PCT/TR2024/050054

§ 371 Date: Jul. 9, 2025

(30) Foreign Application Priority Data
Jan. 25, 2023 (TR) 2023/000880

(51) Int. Cl. G06Q 30/0601; G06Q 30/018

(52) U.S. Cl. CPC G06Q 30/0603; G06Q 30/018

(57) ABSTRACT

The invention relates to a system enabling the product information to be updated by the same or another seller for the purpose of maximizing the sales of a product, the basic information about which was entered in a catalog by a seller, and to a method comprising the algorithmic processes among the components that constitute said update system.

### TECHNICAL FIELD

Our invention relates to a single catalog product update system for enhancing the content quality of the products in the single catalogs used on the e-commerce websites and to a method for the same.

More specifically, the invention relates to a system enabling the product information to be updated by the same or another seller for the purpose of maximizing the sales of a product, the basic information about which was entered in a catalog by a seller, and to a method comprising the algorithmic processes among the components that constitute said update system.

### STATE OF THE ART

The commerce emerged in order to enable the people to meet their needs and is defined as the exchange of the goods with the other articles having economic value (e.g., currency, etc.) during the period from the manufacturing process to the consumption process of said goods. The commerce, the foundations of which were laid via the method of exchange in the ancient civilizations, is today possible to be done in numerous ways. Specifically, the concept of e-commerce has emerged along with the advances in the technology. E-commerce is the short form of the phrase electronic commerce and is defined as the conduct of the commerce in the electronic media.

The structures such as the lists, etc. prepared according to a certain order are referred to as the catalogs. In other words, cataloging is the process of bringing together in an orderly manner the items that serve the same purpose. Said process may be performed via different methods, among which the best known is the arrangement in alphabetical order. When considered from the perspective of commerce, the word catalog has great importance. The sellers use the catalogs in order to sell their products according to a certain order, while the customers use the same in order to easily find the products they will purchase.

The fact that the e-commerce is conducted on the online environments brings about the need for the online catalogs. Especially, the e-commerce companies operating as a marketplace prefer said catalog form. Said catalogs contain the products and the information about these products (product name, product description, product properties, etc.). Said information is entered by the sellers to the system. The single catalog system, which is another type of online catalog, is based on the concept that one piece of each product is included in the catalog and that different sellers sell said product at different prices.

The contents of information about the products (product name, product description, product properties, etc.) appear as one of the most important factors contributing to the sales of said products. In some catalog systems available in the state of the art, it is not possible to update said product information contents. This presents a danger especially in the case where more than one seller carry out the sale of the same product. The reason is that the entered information could be erroneous/incorrect or that it is necessary to update the entered product information from time to time.

As a result, the presence of the above-mentioned drawbacks proves that there is a requirement for our present invention.

### Object and Brief Description of the Invention

An object of the invention is to provide a single catalog product update system for enhancing the content quality of the products in the single catalogs used on the e-commerce websites.

Another object of the invention is to provide a method for enhancing the content quality of the products in the single catalogs used on the e-commerce websites.

A single catalog product update system for use in the single catalogs available on the e-commerce websites, said single catalog product update system comprises, in order to enhance the product content quality in the single catalogs and thereby maximize the product sales, the components of
at least one product quality system, which
receives as data input the information about
the product name; the number of images and their quality; whether a video is available; the length of the product description; whether the images, videos, tables and lists are available in the product description; and whether the property values (color, size, etc.) based on product type were entered,
subsequently receives as input the data about the sales volume based on said information,
   receives the two different data mentioned in the two paragraphs above and calculates the product content quality score once for each category available in the single product catalog in order to determine which information provides contribution to the product sales,
   transmits the calculated score as an output to the management system via the message unit, and
   recalculates the product content quality score for the products, which have a positive response for the update request and which are updated in the single product catalog;
at least one web search robot, which
performs in the internet environment a search including also the rivals, enriches according to the results of said search the product contents by making additions to the product content information updated by the seller or integrator and received by said web search robot from said management system via the message unit, and transmits the enriched product contents to the management system via the message unit;
at least one validation system, which
subjects said update contents—i.e. the product contents, which it receives from said management system via the message unit and which are updated by a seller or an integrator and which are then enriched in said web search robot, —to the checks (banned word check, inappropriate image check, etc.) and transmits the result it generates after said checks to the management system via the message unit, before the products whose product contents are updated are added to a single product catalog;
at least one seller product score system, which
receives as data input the information about
the data rate entered by the seller for the respective product, the sales volume of the seller for the respective product, the points given by the customers to the seller, and the average delivery time of the seller,
   calculates using the received data input the seller content score in order to decide whether the party (the seller or the integrator) performing the update is authorized to do so and
   transmits the calculated score as an output to the management system via the message unit; and
at least one management system, which
takes into account the seller content score calculated by said seller product score system and decides
   on rejecting the update request sent by the seller or the integrator,
   on forwarding the update request sent by the seller or the integrator to a team of operation via a service and as a data format in order to be subjected to manual check, or
   if the response to the update request is positive, on transmitting the updated product information to a single product catalog via the message unit.

A single catalog product update method for use in the single catalogs available on the e-commerce websites characterized in that said single catalog product update method comprises, in order to enhance the product content quality in the single catalogs and thereby maximize the product sales, the process steps of
said product quality system receiving as data input the information about—the product name; the number of images and their quality; whether a video is available; the length of the product description; whether the images, videos, tables and lists are available in the product description; and whether the property values (color, size, etc.) based on product type were entered-, subsequently receiving as input the data about the sales volume based on said information, and calculating the product content quality score once for each category available in the single product catalog in order to determine which information provides contribution to the product sales;
said product quality system displaying to the seller or the integrator, via a service and as a data format, a product content quality score for the products currently available in said single product catalog, wherein said score was previously generated based on the points determined via fixed decisions for each field like product name, number of images, description contents, etc. in the different product types;
said sellers transmitting the product content update request to a management system
   via a service and as a data format and by means of a user interface if said sellers wish to perform the update only for a single product, or
   via a service and as a data format and by means of the digital table document if said sellers wish to perform a collective product update,
while said integrators, in case they wish to perform a product update, transmitting the product content update request to a management system
   via a service and as a data format and by means of API;
said web search robot performing in the internet environment a search including also the rivals in order to make additions to the product content information updated by the seller or the integrator and received by said web search robot from said management system via the message unit and enriching according to the results of said search the update contents (product contents) by making additions to said product content information;
said validation system, before the products whose product contents are updated are added to a single product catalog, processing the contents by subjecting the product contents, which it receives from said management system via the message unit and which are updated by a seller or an integrator and which are then enriched in said web search robot, to the checks of
   banned word check and
   inappropriate image check;
said seller product score system receiving as data input the information about—the data rate entered by the seller for the respective product, the sales volume of the seller for the respective product, the points given by the customers to the seller, and the average delivery time of the seller—and calculating the seller content score in order to decide whether the party (the seller or the integrator) performing the update is authorized to do so;
said management system taking into account the seller content score calculated by said seller product score system and deciding whether the seller or the integrator is authorized to perform the update;
said management system taking into account the seller content score calculated by said seller product score system and rejecting the update request sent by the seller or the integrator, or forwarding said update request via a service and as a data format to the operation in order to be checked manually;
said management system taking into account the data processed by said validation system and the data about whether the authority of update is present as decided in the related step, approving the update request, or forwarding the update request via a service and as a data format to the operation in order to be checked manually;
said management system transmitting the update data for the requests approved by said management system or operation to the single product catalog via the message unit and said single product catalog returning a result to the management system via the message unit;
said product quality system recalculating the product content quality score for the products, which have a positive response for the update request and which are updated in the single product catalog; and
said management system displaying/transmitting the result of the request along with the new-calculated product content quality score if the update request has been approved or the result of the request along with the reason for rejection if the update request has not been approved and with the new product content quality score, if any,
to the seller
   via a service and as a data format and by means of a user interface for a single product, or
   via a service and as a data format and by means of a digital table document for a collective group of products, or
to the integrator
   via a service and as a data format and by means of an API.

Our invention relates in particular to a single catalog product update system, which is intended to enhance the content quality of the products in the single catalogs used on the e-commerce websites and which achieves said enhancement of the content quality of the products in the single catalogs after the processes of calculating, by the product quality system, the product content quality score through the use of the machine learning method, displaying the previous product content quality scores to the sellers or integrators, transmitting the product content update request of the sellers or integrators to the management system via the user interface, document or API, enriching the update contents by the web search robot, processing the received update contents in the validation system, calculating the seller content score for the purpose of authority check, deciding, by the management system, about the authority of update considering the seller content score, deciding, by the management system, to reject the update request or to forward the update request to the operation, approving the update request or forwarding the update request to the operation for manual check, transmitting the update data to the single product catalog for the requests approved by the management system or the operation team and obtaining the result, recalculating, by the product quality system, the product content quality score and displaying/transmitting the result of the request to the seller/integrator.

### BRIEF DESCRIPTION OF THE FIGURES

FIG. 1: A REPRESENTATIVE IMAGE WHERE THE GENERAL SYSTEM STRUCTURE IS MODELED.

FIG. 2: A representative image where the general system structure and the inter-system communication are illustrated by the duplex lines and the algorithmic processes are modeled.

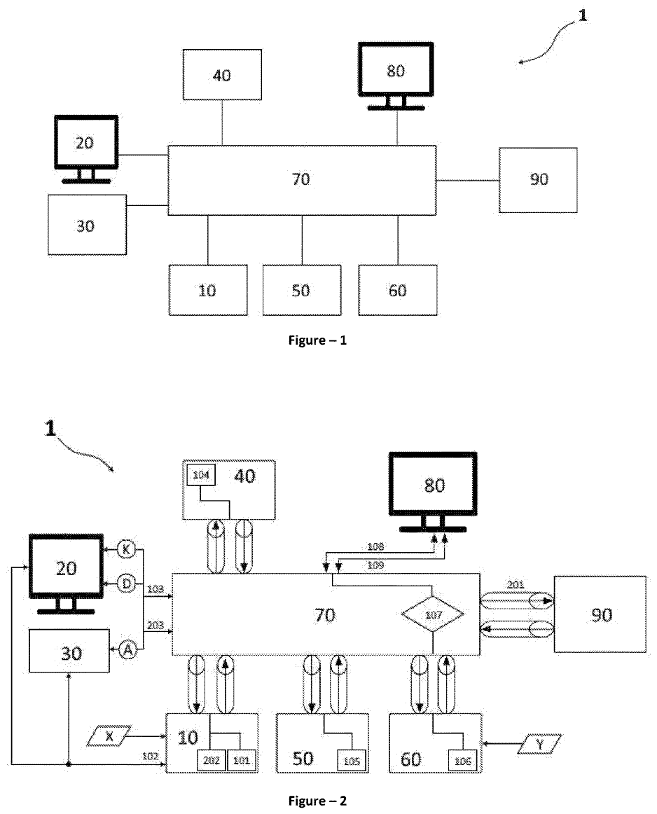

### REFERENCE NUMERALS

1 Single catalog product update system
10 Product quality system
20 Seller
30 Integrator
40 Web search robot
50 Validation system
60 Seller product score system
70 Management system
80 Operation
90 Single product catalog
101 Calculating the product content quality score
102 Displaying a previously generated product content quality score via a service and as a data format to the seller or integrator
103 Transmitting the product content update request to a management system
104 Enriching the update contents
105 Processing the contents
106 Calculating the seller content score
107 Deciding whether the authority of update is present
108 Rejecting the update request or forwarding the same via a service and as a data format to the operation in order to be checked manually
109 Approving the update request or forwarding the same via a service and as a data format to the operation in order to be checked manually
201 Transmitting, by said management system, the update data for the approved requests to the single product catalog via the message unit and returning, by said single product catalog, a result to the management system via the message unit
202 Recalculating the product content quality score
203 Displaying/transmitting to the seller/integrator the result of the request and the new product content quality score, if any
A API
D Document
K User interface
X All the input (information) provided to the product content system
Y All the input (information) provided to the seller product score system

### DETAILED DESCRIPTION OF THE INVENTION

Our invention relates to a single catalog product update system (1) for enhancing the content quality of the products in the single catalogs used on the e-commerce websites and to a method for the same.

More specifically, the invention relates to a system (1) enabling the product information to be updated by the same or another seller (20) for the purpose of maximizing the sales of a product, the basic information about which was entered in a catalog by a seller (20), and to a method comprising the algorithmic processes among the components that constitute said update system.

Our invention, i.e. the single catalog product update system (1), basically consists of the structures of the product quality system (10), the seller (20), the integrator (30), the web search robot (40), the validation system (50), the seller product score system (60), the management system (70), the operation (80) and the single product catalog (90) and the algorithmic process steps (101, 102, 103, 104, 105, 106, 107, 108, 109, 201, 202, 203) employed among said structures.

API (Application Programming Interface) is described as a software tool that enables a software to use the features defined in another software.

REST (Representational State Transfer) is a type of software architecture that came into existence in the early 2000s. Said REST structure enables a communication to be established in a quick and practical manner between the client-server. Said REST structure enables the communication between the client-server via the data format (XML or JSON). The web services written in a manner compatible with said REST architecture are referred to as RESTful service.

Microservices is a type of software architecture where different work tasks are separated into smaller independent services and each microservice is formed to perform only one task.

The communication between the structures of the seller (20), the integrator (30) and the operation (80) and the management system (70) shown in FIG. 2 is provided via a service and the RESTful web service is preferably used in our invention. The remaining structures of the product quality system (10), the web search robot (40), the validation system (50), the seller product score system (60), the management system (70) and the single product catalog (90) are positioned as microservices into the single catalog product update system (1) and they perform only a certain function. The communication among said structures is provided in an asynchronous manner by means of the duplex lines. Using the duplex line data structures between said microservices offers the advantages of
scalability,
sustainability,
testability, and
flexibility.

Here, the asynchronous line structure is controlled by the message unit and RabbitMQ is preferably used as the message unit in our invention. Said message unit (RabbitMQ) is a message queuing system and is defined as a system, which transmits a message with a certain format (JSON, XML, etc.) received from a location to another location in due course—in the right time. Here, one of the most important benefits of using the message unit (RabbitMQ) is the ability to rapidly transmit back a response message when a request message is received. In this way, a very short response time results and our system becomes able to operate faster. Further, each cylinder seen in FIG. 2 refers to a line. Since high extent of data flow—message flow—occurs in the duplex communication between said product quality system (10), web search robot (40), validation system (50), seller product score system (60), management system (70) and single product catalog (90), the message unit provides the communication and manages the process by delivering the messages to the desired destinations according to their order.

As explained in the preceding paragraphs, the structures of the seller (20), the integrator (30) and the operation (80) establish communication with a web service. The format for the data necessary to establish communication with said services is preferably chosen as JSON.

The examples of JSON request and JSON request result data for a scenario where said seller (20) transmits an update request to the management system (70) for the purpose of updating the product and the management system (70) responds to said update request are provided below.

### JSON Request Example

| | |
|---|---|
| 1 | { |
| 2 | “ticketId”:“1107835”, |
| 3 | “merchant”:{ |
| 4 | “merchantId”:“63c58fec-9326-4672-b75e-cdc9f5c3b186”, |
| 5 | “name”:“Store A” |
| 6 | }, |
| 7 | “products”:[ |
| 8 | { |
| 9 | “productId”:“6b512e1e-d3a2-4b44-a3a2-106e449fd74c”, |
| 10 | “variantSku”:“HBCV00002Q5KTP”, |
| 11 | “changes”:[ |
| 12 | { |
| 13 | “field”:“NAME”, |
| 14 | “oldValue”:“Sol & Luna Leopard Dual Side Pin Set”, |
| 15 | “newValue”:“Sol and Luna Leopard Dual Side Pin Set” |
| 16 | }, |
| 17 | { |
| 18 | “field”:“DESCRIPTION”, |
| 19 | “oldValue”:“<div>Our Product is Sold As A Single Item. </div>”, |
| 20 | “newValue”:“<div>Our Product is Sold As A Pair.</div>” |
| 21 | } |
| 22 | ] |
| 23 | } |
| 24 | } |
| 25 | } |

### JSON Request Result Example

| | |
|---|---|
| 1 | { |
| 2 | “products”:[ |
| 3 | { |
| 4 | “productId”:“39e39597-bbbc-4b0a-94bd-3d26b3aab821”, |
| 5 | “variantSku”:“HBCV00002Q5KTP”, |
| 6 | “qualityScore”:“8.7”, |
| 7 | “changes”:[ |
| 8 | { |
| 9 | “changeId”:”99308e0f-8d11-419b-b937-125da70933c7”, |
| 10 | “field”:“NAME”, |
| 11 | “status”:“APPROVE”, |
| 12 | “oldValue”:“Sol & Luna Leopard Dual Side Pin Set”, |
| 13 | “newValue”:“Sol and Luna Leopard Dual Side Pin Set ” |
| 14 | }, |
| 15 | { |
| 16 | “changeId”:“7564e9ed-38b4-4667-8ce2-1199573238e3”, |
| 17 | “field”:“DESCRIPTION”, |
| 18 | “status”:“APPROVE”, |
| 19 | “oldValue”:“<div> Our Product is Sold As A Single Item.</div>”, |
| 20 | “newValue”:“<div> Our Product is Sold As A Pair.</div>” |
| 21 | } |
| 22 | ] |
| 23 | } |
| 24 | } |
| 25 | } |

If the above-mentioned scenario is examined in more detail;

For JSON data for the update request;
“ticketId” on line 2 represents the update request number and has the value of “1107835”.
“name” on line 5 represents the name of the store and the name of the store is “Store A”.
“variantSku” on line 10 represents the product code and the product code is
“HBCV00002Q5KTP”.
The phrases “field” on lines 13 and 18 refer to the sections the seller (20) wishes to update. Said sections (“NAME” and “DESCRIPTION”) are shown for exemplary purposes and it is possible to update also the other content sections.
“oldValue” on line 14 represents the current name of the product whose name is wished to be changed and the current name of the product is “Sol & Luna Leopard Dual Side Pin Set”.
“newValue” on line 15 represents the new name of the product whose name is wished to be changed and the new name of the product subject to the update request is “Sol and Luna Leopard Dual Side Pin Set”.
“oldValue” on line 19 represents the current description for the product and the current description is “<div>Our Product is Sold As A Single Item. </div>”
“newValue” on line 20 represents the desired updated form of the product description and the desired updated form of the description is “<div>Our Product is Sold As A Pair.</div>”

More specifically, the seller (20) sends, with the application number “1107835”, an update request to the management system (70) for the update of the information in the fields “NAME” and “DESCRIPTION” by “Store A” for the product with the code “HBCV00002Q5KTP”.

For JSON data for the update request result;
“variantSku” on line 5 represents the product code and the product code is “HBCV00002Q5KTP”.
“qualityScore” on line 6 represents the content quality score of the product and has the value of “8.7′”.
the phrases “field” on lines 10 and 17 refer to the sections the seller (20) wishes to update. Said sections (“NAME” and “DESCRIPTION”) are shown for exemplary purposes and it is possible to update also the other content sections.
The phrases “status” on lines 11 and 18 represent the approval/rejection status decided by the management system (70) for the sections “NAME” and “DESCRIPTION” for the product and the approval/rejection status for both sections is “APPROVE”.
“oldValue” on line 12 represents the current name of the product whose name is wished to be changed and the current name of the product is “Sol & Luna Leopard Dual Side Pin Set”.
“newValue” on line 13 represents the new name of the product whose name is wished to be changed and the new name of the product subject to the update request is “Sol and Luna Leopard Dual Side Pin Set”.
“oldValue” on line 19 represents the current description for the product and the current description is “<div>Our Product is Sold As A Single Item. </div>”
“newValue” on line 20 represents the desired updated form of the product description and the desired updated form of the description is “<div>Our Product is Sold As A Pair.</div>”

More specifically, the management system (70) notifies, separately as a “status” for each field, the approval/rejection status for the request for the update of the information in the fields “NAME” and “DESCRIPTION” for the product with the code “HBCV00002Q5KTP”. Said approval/rejection status is defined as “APPROVE” by the management system (70). Here, “qualityScore” is recalculated for each positive status of “APPROVE” and the fields with “APPROVE” are included in said calculation.

Hereinafter, the operation of the system and the interaction between the parts of the system will be described.

Said product quality system (10) has a product content quality score for the products currently available in said single product catalog (90), wherein said score was previously generated based on the points determined via fixed decisions for each field like product name, number of images, description contents, etc. in the different product types. Here, said product quality system (10) calculates a product content quality score in order to enable said score to be changed. Said calculation is performed for the new products entered or for the products updated.

The above-mentioned calculation is performed by the use of the machine learning method, in order to determine what information provides contribution to the sales for each category. Here, the product quality system (10) is a machine learning model. The information about
the product name,
the number of images and their quality,
the availability of a video,
the length of the product description,
the availability of images, videos, tables and lists in the product description,
the input of the property values (color, size, etc.) based on product type
   is provided as an input to the machine learning model and the data about the sales volume in response to such information is fed to said model. All the inputs provided and fed to said machine learning model are represented with (X) in FIG. 2. Moreover, said machine learning model calculates the product content quality score only once for each product available in the catalog.

Further, said model calculates the product content quality score for the first time for the products added to the catalog and recalculates the product content quality score for the products updated.

More specifically, said product quality system (10)
receives as data input the information about the product name; the number of images and their quality; whether a video is available; the length of the product description; whether the images, videos, tables and lists are available in the product description; and whether the property values (color, size, etc.) based on product type were entered;
subsequently receives as input the data about the sales volume based on said information;
uses the two different data mentioned in the two paragraphs above as input and calculates the product content quality score once for each category available in the single product catalog (90) in order to determine which information provides contribution to the product sales (101); transmits the calculated score as an output to the management system (70) via the message unit (RabbitMQ); and recalculates the product content quality score for the products, which have a positive response for the update request and which are updated in the single product catalog (90) (202).

Said product quality system (10) displays to the seller (20) or the integrator (30), via a service (RESTful) and as a data format (JSON), a product content quality score for the products currently available in said single product catalog (90), wherein said score was previously generated based on the points determined via fixed decisions for each field like product name, number of images, description contents, etc. in the different product types (102); and then, the seller (20) or the integrator (30) is able to increase the product content quality score by updating the product data. Said seller (20) transmits, by means of the user interface (K) if said seller (20) wishes to perform the update only for a single product and by means of the digital table document (D) if said seller (20) wishes to perform a collective product update, the update request along with the update information to said management system (70). When said integrators (30) wish to perform a product update, they transmit the update request and the update information to said management system (70) by using the APIs (A) opened by said management system (70).

More specifically, said seller (20) transmits, via a service (RESTful) and as a data format (JSON) and by means of a user interface (K) if said seller (20) wishes to perform the update only for a single product and via a service (RESTful) and as a data format (JSON) and by means of the digital table document (D) if said seller (20) wishes to perform a collective product update, the product content update request to the management system (70), while said integrator (30), when said integrator (30) wishes to perform a product update, transmits, via a service (RESTful) and as a data format (JSON) and by means of the API (A), the product content update request to the management system (70) (103).

The product data updated by said seller (20) or integrator (30) is transmitted from the management system (70) to the web search robot (40) via the message unit (RabbitMQ). Then, said web search robot (40) performs in the internet environment a search including also the rivals, enriches according to the results of said search the product contents by making additions to the product content information updated by the seller (20) or integrator (30) (104), and transmits the enriched product contents to the management system (70) via the message unit (RabbitMQ). Here, the web search robot (40) is an internet content search robot (Google, Yandex, etc.), which combines and reports the data available on the internet.

More specifically, said web search robot (40) performs in the internet environment a search including also the rivals in order to make additions to the product content information, which is updated by the seller (20) or integrator (30) and which is received by said web search robot (40) from said management system (70) via the message unit (RabbitMQ), enriches according to the results of said search the update contents/product contents by making additions to said product content information (104), and transmits the enriched product contents to the management system (70) via the message unit (RabbitMQ).

The update contents enriched in said web search robot (40) are transmitted to the management system (70). Said management system (70) transmits the enriched update contents to a validation system (50) via the message unit. Said enriched update contents are processed in said validation system (50) (105).

Owing to said validation system (50), the products whose product data have been updated by said seller (20) are not immediately reflected on the catalog. Thus, it is ensured that the products updated by the seller (20) are not immediately reflected on the catalog. Likewise, the update data entered by said integrator (30) are checked by the validation system (50) and it is ensured that the updated products are not immediately reflected on the catalog. Said validation system (50) provides the checks such as the banned word check, inappropriate image check, etc. and generates a result according to said checks. By this means, the products with a trademark and with single seller are updated in the catalog as a result of the basic validation process.

Said validation system (50) processes the product contents, which it receives from said management system (70) via the message unit (RabbitMQ) and which are updated by a seller (20) or an integrator (30) and which are then enriched in said web search robot (40), by subjecting the product contents of said products to the banned word check and inappropriate image check before they are added to a single product catalog (90) (105).

More specifically, before the products whose product contents are updated are added to said single product catalog (90), said validation system (50) subjects said update contents—i.e. the product contents, which it receives from said management system (70) via the message unit (RabbitMQ) and which are updated by a seller (20) or integrator (30) and which are then enriched in said web search robot (40), —to the checks (banned word check, inappropriate image check, etc.) and transmits the result it generates after said checks to the management system (70) via the message unit (RabbitMQ).

Said seller product score system (60) has a seller content score previously generated based on the points determined via fixed decisions for each field like the data rate already entered by the seller (20) for the respective product, the sales volume of the seller (20) for the respective product, etc.

Here, in order to enable said score to be changed, said seller product score system (60) calculates the seller content score (106). Here, the seller content score is calculated for the new sellers who have joined or the sellers whose information has been updated. Said calculation is performed by the use of the machine learning method in order to decide whether the party performing the update is authorized to do so. Here, the seller product score system (60) is a machine learning model. The information (Y) about
the data rate entered by the seller (20) for the respective product,
the sales volume of the seller (20) for the respective product,
the points given by the customers to the seller (20), and
the average delivery time of the seller (20)
   is provided as input to the machine learning model and the seller content score is calculated in return (106).

More specifically, said seller product score system (60) receives the information about the data rate entered by the seller (20) for the respective product, the sales volume of the seller (20) for the respective product, the points given by the customers to the seller (20), and the average delivery time of the seller (20) as the data input, calculates the seller content score in order to decide whether the party (the seller (20) or the integrator (30)) performing the update is authorized to do so (106) and transmits the calculated score as an output to the management system (70) via the message unit (RabbitMQ). All of the above-mentioned data input consisting of the four items are represented with (Y) in FIG. 2.

Said management system (70), taking into account the seller content score calculated by said seller product score system (60) as described in the preceding paragraph, decides whether the seller (20) or the integrator (30) is authorized to perform the update (107). Then, said management system (70), taking into account the seller content score calculated by said seller product score system (60), rejects the update request sent by the seller (20) or the integrator (30), or forwards the update request via a service (RESTful) and as a data format (JSON) to the operation (80) in order to be checked manually (108). Said management system (70), taking into account the data processed by said validation system (50) and the data about whether the authority of update is present as decided in step 107, approves the update request, or forwards the update request via a service (RESTful) and as a data format (JSON) to the operation (80) in order to be checked manually (109).

The update data for the requests approved by said management system (70) or by the team of operation (80) is transmitted by said management system (70) to the single product catalog (90) by the use of the message unit (RabbitMQ) and said single product catalog (90) returns a result to said management system (70) by means of the message unit (RabbitMQ) (201). Subsequently, the approved products are updated in the single product catalog (90). The single product catalog (90) mentioned here is a system where the sellable forms of all the products are kept along with the all the category and product information.

Then, the product quality system (10) recalculates the product content quality score for the products, which have a positive response for the update request and which are updated in the single product catalog (90) (202). Here, the product content quality score calculated for the second time involves the processes employed when the product content quality score was calculated the first time. Unlike said first calculation, the product content quality score is expected to increase in the positive direction, since an update has been made.

Finally, the result of the request and the new product content quality score, if any, are displayed/transmitted to the seller/integrator (203). Here, said management system (70) displays/transmits the result of the request along with the new-calculated product content quality score if the update request has been approved or the result of the request along with the reason for rejection if the update request has not been approved and with the new product content quality score, if any,
to the seller (20)
   via a service (RESTful) and as a data format (JSON) and by means of a user interface (K) for a single product, or
   via a service (RESTful) and as a data format (JSON) and by means of a digital table document (D) for a collective group of products, or
to the integrator (30)
   via a service (RESTful) and as a data format (JSON) and by means of an API (A) (203).

In its most general form, said management system (70), taking into account the seller content score calculated by said seller product score system (60), decides on rejecting the update request sent by the seller (20) or the integrator (30), on forwarding the update request to the team of operation (80) via a service (RESTful) and as a data format (JSON) in order for the manual check to be performed, or, if the result of the update request is positive, on transmitting the updated product to the single product catalog (90) via the message unit (RabbitMQ).

Moreover, said management system (70) transmits/displays to the seller (20) via the display interface the result of the request along with the new-calculated product content quality score if the update request has been approved or the result of the request along with the reason for rejection if the update request has not been approved and with the new product content quality score, if any. Said management system (70) transmits/displays to the integrator (30) via an API (A) the result of the request along with the new-calculated product content quality score if the update request has been approved or the result of the request along with the reason for rejection if the update request has not been approved and with the new product content quality score, if any. Here, the integrator (30) company is, by using API (A), able to obtain the information such as the result of the request, the product content quality score and the reason for rejection by performing queries at certain intervals.

After all of the processes mentioned above, the product content quality in the single catalog is increased.

1. A single catalog product update system for use in single catalogs available on e-commerce websites wherein said single catalog product update system comprises, in order to enhance the product content quality in the single catalogs and thereby maximize the product sales, the components of:
at least one product quality system, which:
receives as data input information about a product name; a number of images and their quality; whether a video is available; a length of a product description; whether images, videos, tables and lists are available in the product description; and whether property values (color, size, etc.) based on product type were entered,
subsequently receives as input data about sales volume based on said information;
receives the two different data mentioned in the two paragraphs above and calculates a product content quality score once for each category available in the single product catalog in order to determine which information provides contribution to the product sales;
transmits the calculated score as an output to the management system via the message unit; and
recalculates the product content quality score for the products, which have a positive response for the update request and which are updated in the single product catalog;
at least one web search robot, which performs in the internet environment a search including also rivals, enriches according to the results of said search the product contents by making additions to the product content information updated by the seller or integrator and received by said web search robot from said management system via the message unit, and transmits the enriched product contents to the management system via the message unit;
at least one validation system, which subjects said update contents—i.e. the product contents, which it receives from said management system via the message unit and which are updated by a seller or an integrator and which are then enriched in said web search robot, to the checks (banned word check, inappropriate image check, etc.) and transmits the result it generates after said checks to the management system via the message unit, before the products whose product contents are updated are added to a single product catalog;
at least one seller product score system, which receives as data input the information about the data rate entered by the seller for the respective product, the sales volume of the seller for the respective product, the points given by the customers to the seller, and the average delivery time of the seller;
calculates using the received data input the seller content score in order to decide whether the party (the seller or the integrator) performing the update is authorized to do so; and
transmits the calculated score as an output to the management system via the message unit; and
at least one management system, which takes into account the seller content score calculated by said seller product score system and decides:
on rejecting the update request sent by the seller or the integrator;
on forwarding the update request sent by the seller or the integrator to a team of operation via a service and as a data format in order to be subjected to manual check; or
if the response to the update request is positive, on transmitting the updated product information to a single product catalog via the message unit.

2. A single catalog product update system according to claim 1, wherein said product quality system is a machine learning model.

3. A single catalog product update system according to claim 1, wherein said web search robot is an internet search robot, which combines and reports the data available on the internet.

4. A single catalog product update system according to claim 1, wherein said seller product score system is a machine learning model.

5. A single catalog product update system according to claim 1, wherein said message unit is RabbitMQ.

6. A single catalog product update system according to claim 1, wherein the data format used to establish communication with said services is JSON.

7. A single catalog product update method for use in single catalogs available on commerce websites wherein said single catalog product update method comprises, in order to enhance the product content quality in the single catalogs and thereby maximize the product sales, the process steps of:
said product quality system receiving as data input the information about: a product name; a number of images and their quality; whether a video is available; a length of a product description; whether the images, videos, tables and lists are available in the product description; and whether property values (color, size, etc.) based on product type were entered, subsequently receiving as input the data about the sales volume based on said information, and calculating the product content quality score once for each category available in the single product catalog in order to determine which information provides contribution to the product sales;
said product quality system displaying to a seller or an integrator, via a service and as a data format, a product content quality score for the products currently available in said single product catalog, wherein said score was previously generated based on the points determined via fixed decisions for each field like product name, number of images, description contents, etc. in the different product types;
said sellers transmitting the product content update request to a management system;
via a service and as a data format and by means of a user interface if said sellers wish to perform the update only for a single product, or
via a service and as a data format and by means of the digital table document if said sellers wish to perform a collective product update, while said integrators, in case they wish to perform a product update, transmitting the product content update request to a management system;
via a service and as a data format and by means of API;
said web search robot performing in the internet environment a search including also the rivals in order to make additions to the product content information updated by the seller or the integrator and received by said web search robot from said management system via the message unit and enriching according to the results of said search the update contents (product contents) by making additions to said product content information;
said validation system, before the products whose product contents are updated are added to a single product catalog, processing the contents by subjecting the product contents, which it receives from said management system via the message unit and which are updated by a seller or an integrator and which are then enriched in said web search robot, to the checks of:
banned word check; and
inappropriate image check;
said seller product score system receiving as data input the information about the data rate entered by the seller for the respective product, the sales volume of the seller for the respective product, the points given by the customers to the seller, and the average delivery time of the seller; and calculating the seller content score in order to decide whether the party (the seller or the integrator) performing the update is authorized to do so;
said management system taking into account the seller content score calculated by said seller product score system and deciding whether the seller or the integrator is authorized to perform the update;
said management system taking into account the seller content score calculated by said seller product score system and rejecting the update request sent by the seller or the integrator, or forwarding said update request via a service and as a data format to the operation in order to be checked manually;
said management system taking into account the data processed by said validation system and the data about whether the authority of update is present as decided previously, approving the update request, or forwarding the update request via a service and as a data format to the operation in order to be checked manually;
said management system transmitting the update data for the requests approved by said management system or operation to the single product catalog via the message unit and said single product catalog returning a result to the management system via the message unit;
said product quality system recalculating the product content quality score for the products, which have a positive response for the update request and which are updated in the single product catalog; and
said management system displaying/transmitting the result of the request along with the new-calculated product content quality score if the update request has been approved or the result of the request along with the reason for rejection if the update request has not been approved and with the new product content quality score, if any, to the seller:
via a service and as a data format and by means of a user interface for a single product, or
via a service and as a data format and by means of a digital table document for a collective group of products, or
to the integrator;
via a service and as a data format and by means of an API.
